(19) United States
(12) Patent Application Publication
(10) Pub. No.: US 2014/0097222 A1
(43) Pub. Date: Apr. 10, 2014

(54) Mobile Equipment Rack

(71) Applicant: Robert Robinson, Bloomfield, KY (US)

(72) Inventor: Robert Robinson, Bloomfield, KY (US)

(21) Appl. No.: 14/021,616

(22) Filed: Sep. 9, 2013

Related U.S. Application Data
(60) Provisional application No. 61/710,959, filed on Oct. 8, 2012.

(51) Int. Cl. B60R 9/00

(52) U.S. Cl. CPC B60R 9/00
USPC 224/401

(57) ABSTRACT

Disclosed is a mobile equipment rack suitable for holding firearms, fishing rods, or other equipment. The equipment rack comprises a base portion capable of keeping the lower portion of firearms or other equipment steady, a top portion with notches or other suitable means capable of receiving the upper portion of firearms or other equipment, two members on either side of the base that connect the base portion to the top portion, and two accessory rail attachments adapted to engage with the support apertures of an all-terrain vehicle (ATV) flatbed, such as those vehicles having support apertures along the raised sides of their flatbed cargo area. The mobile utility equipment rack allows multiple guns or other types of equipment to be securely stored in a safe, easy-to-reach fashion, while freeing up space in the ATV's flatbed for storing other items.

### CROSS REFERENCE TO RELATED APPLICATION

This application claims the benefit of U.S. Provisional Application No. 61/710,959 filed on Oct. 8, 2012, entitled “Utility Vehicle Gun Carrier.” The above identified patent application is herein incorporated by reference in its entirety to provide continuity of disclosure.

### BACKGROUND OF THE INVENTION

1. Field of the Invention

The present invention relates to mobile storage devices, specifically mobile storage devices that are specially designed to work with ATVs and carry weapons and other equipment.

ATV flatbeds create a number of unique problems when it comes to transporting certain types of equipment. Fragile equipment, such as fishing rods, can be broken by other objects rolling around in the ATV's flatbed. Even sturdier equipment, such as firearms, can be scratched or otherwise damaged by the abrasive surface of the flatbed or by other objects in the flatbed. Safety is also a major concern when transporting multiple firearms on an ATV. If multiple firearms are stored in the flatbed of an ATV, there is a risk of unintended discharge of the firearms if they collide with each other. Additionally, it may be very inconvenient to access the firearms if they are merely piled on top of each other in the flatbed and are not organized and separated. An equipment rack hanging off the exterior of the ATV also frees up space for the storage of additional equipment in the ATV's flatbed.

Several types of mobile gun racks have been disclosed in the prior art, but they have several inherent problems. Some types of mobile firearm racks are designed only for use with trucks and are not compatible with ATVs. This is a major disadvantage because often when hunting or participating in sporting events, the terrain is too rough for a pickup truck and an ATV must be used to reach the desired destination. Other types of firearm racks are designed to mount to the floor of a vehicle, which takes up a substantial amount of space that could otherwise be used to store other equipment. Finally, other types of firearm racks that have been specifically designed for ATVs are only capable of storing a single firearm or take up valuable space in the flatbed.

The present invention addresses all of the problems faced by firearm owners who wish to transport their firearms and other equipment using their ATVs. The present invention mounts on the exterior wall of the ATV's flatbed, thereby freeing up a substantial amount of space for the storage of other equipment in the ATV's flatbed. The present invention mounts to the exterior of an ATV via accessory rail attachments that engage support apertures present along the top edge of some models of ATV flatbed side rails. Engaging these support apertures allows the mobile equipment rack to be held upright and steady, ensuring that equipment will be easy to access and minimally jostled during transport. The present invention also allows for the storage of multiple firearms in a safe and easy-to-access manner by separating them and storing them vertically in order to prevent unintended discharge of the firearms through collisions during transportation on the ATV.

2. Description of the Prior Art

Devices have been disclosed in the prior art that relate to mobile equipment storage. These include devices that have been patented and published in patent application publications. These devices generally relate to weapon racks that are secured at various positions on trucks or ATVs. The following is a list of devices deemed most relevant to the present disclosure, which are herein described for the purposes of highlighting and differentiating the unique aspects of the present invention, and further highlighting the drawbacks existing in the prior art.

These prior art devices have several known drawbacks. Specifically, U.S. Pat. No. 2,958,422 to Caloiero describes a gun rack that is primarily designed for installation into a cabinet. The gun rack comprises a pair of spaced vertical stiles, a horizontal rail and a vertical rail secured to the stiles, a plurality of oval sockets on the lower rail for receiving the gun butts, and a plurality of spaced openings on the vertical rail corresponding to each of the oval sockets. Although Caloiero discloses a gun rack that stores firearms in an upright position, the gun rack is not specifically designed to be affixed to any type of vehicle.

U.S. Pat. No. 4,057,183 to Ness is another such device that discloses a gun rack attaching to the wheel well of a rear wheel of a pickup truck. Ness is intended to protect guns, fishing rods, and other such equipment from damage caused by being placed in the body of a truck. Such damage can be caused either by the guns or other equipment colliding with each other, by other objects placed on top of the guns or other equipment, or by virtue of the guns rubbing against the abrasive floor of the truck during transportation. The gun rack discloses an M-shaped frame with two vertical legs that attach to the exterior wall of the wheel well, L-shaped support elements attached to the each of the vertical legs, and at least one clip attached to each support element for securing the guns in place. While Ness has a similar concept to the present invention, Ness is not designed to work with ATVs and does not store the guns in a vertical position. A critical aspect of the present invention is that it is specifically designed to work with ATVs to maximize the types of terrain over which the items can be transported.

U.S. Pat. No. 5,524,772 to Simmons discloses a firearm rack that attaches to the rear window of a truck. The firearm rack comprises a frame member having an upper and lower end, an upper and lower cradle member capable of receiving a portion of a firearm, and an upper and lower attachment member that secures the frame member to the rear window of the pickup truck. Simmons is designed to be used with a wide array of pickup trucks; however like Ness, it is not suited for use on an ATV due to ATVs' lack of a rear window.

U.S. Pat. No. 7,137,511 to Crowell discloses a mobile weapon storage system for guns and their accessories that can stand alone or attach to the floor of a vehicle securely. The mobile weapon storage system discloses a variable-width clamp, a weapon shelf, and a frame, which is composed of a left frame member, a right frame member, and a horizontal variable-width member connecting the left and right frames. While this system may adequately secure the firearms and could potentially be adapted for use with an ATV, it takes of valuable space in the ATV's flatbed that could be used to store other equipment. The present invention comprises a vertical gun rack that attaches to the exterior of the ATV's flatbed, thereby freeing up that space to be used to store other objects.

U.S. Pat. No. 7,770,767 to Bartholdy discloses a gun carrier that mounts to the front of an ATV and may be converted from a horizontal gun rack position to a vertical gun rest position. This gun rest position may be used as a firing rest when the ATV is not in motion. The gun carrier discloses a frame member having two ends, one of which is releasably attached to a first mounting structure on the ATV and the other of which is pivotally attached to a second mounting structure, a clamp that releasably locks the first end of the frame member to the mounting structure, a gas spring between the second mounting structure and the frame member, and a gun cradle attached to the frame member. This gun carrier, like the present invention, is specifically designed for ATVs, but it is only capable of securing a single firearm and it attaches to the front of the ATV, rather than along the exterior of an ATV's flat bed.

The present invention is a new and improved equipment rack that stores multiple firearms, is adapted specifically and ideally for use with an ATV, and frees up additional storage space in the ATV's flatbed. The present invention has rail accessory attachments, attached to the two vertical frame members, which engage with holes along the top of the exterior wall of the ATV's flatbed. This allows the equipment rack to hang off the exterior wall of the flatbed along the side of the ATV. The present invention substantially diverges in design elements from the prior art and consequently it is clear that there is a need in the art for an improvement to existing ATV equipment storage devices. In this regard the instant invention substantially fulfills these needs.

### SUMMARY OF THE INVENTION

In view of the foregoing disadvantages inherent in the known types of equipment storage devices now present in the prior art, the present invention provides a new ATV equipment rack wherein the same can be utilized for providing convenience for the user when transporting their firearms while hunting or participating in sporting events while using an ATV.

It is therefore an object of the present invention to provide a new and improved firearm rack device that has all of the advantages of the prior art and none of the disadvantages.

It is another object of the present invention to provide an equipment rack that frees up space in the ATV flatbed for the storage of other objects.

Another object of the present invention is to provide an equipment rack that allows individuals to quickly and easily access their firearms, fishing rods, or other equipment.

A final object of the present invention is to provide an equipment rack that is safe for using during transportation and avoids the risk of inadvertent firearm discharge caused by firearms colliding with each other or other objects during transportation.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of a first embodiment of the present invention, not engaged with the support accessory rail apertures of an ATV.

FIG. 2 shows a front view of the first embodiment of the present invention, focusing on this embodiment's top receiving means.

FIG. 3 shows a front view of the preferred embodiment of the present invention, focusing on this embodiment's top receiving means.

FIG. 4 shows a perspective view of the present invention, demonstrating how it engages with the support apertures along the top of the ATV flatbed accessory rails, thereby maintaining the equipment rack in an upright configuration.

FIG. 5 shows a close-up view of the accessory rail attachment, which engages with an ATV's support apertures to maintain the mobile equipment rack upright and steady during transport.

### DETAILED DESCRIPTION OF THE INVENTION

Reference is made herein to the attached drawings. Like reference numerals are used throughout the drawings to depict like or similar elements of the mobile equipment rack. For the purposes of presenting a brief and clear description of the present invention, the preferred embodiment will be discussed as used for transporting firearms, fishing rods, and other equipment using an ATV model that has support apertures along the top wall of the flatbed side rails. The figures are intended for representative purposes only and should not be considered to be limiting in any respect.

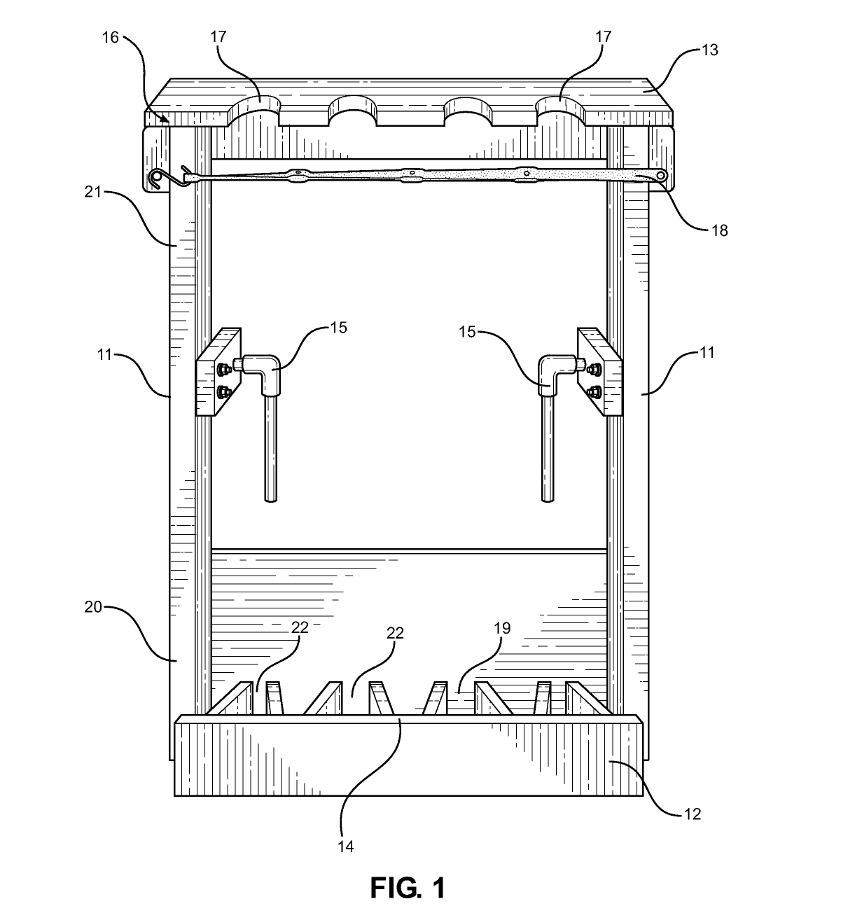

Referring now to FIG. 1, there is shown a front view of an embodiment of the mobile equipment rack. The mobile equipment rack comprises a pair of spaced vertical frame members 11, each with a lower end 20 and an upper end 21. A horizontal base member 12 extends between and connects to each of the lower ends 20 of the vertical frame members 11. The horizontal base member 12 has an upper surface 19, upon which are positioned a plurality of lower receiving means 14 that are adapted to receive the butts of firearms, the handles of fishing rods, or the bases of other such cargo items. In this embodiment, the lower receiving means are a series of V-shaped sockets 22.

A horizontal top member 13 spans between and connects each of the upper ends 21 of the vertical frame members 11. The horizontal top member 13 has a top receiving means 16 that is adapted to receive the barrels of firearms, the shafts of fishing rods, or the tops of other such cargo items. In this embodiment, the top receiving means 16 consists of two components. The first component is a plurality of depressions 17 that are adapted to receive the tops of the cargo items. The number of depressions 17 corresponds to the number of lower receiving means 14, which in this embodiment are V-shaped sockets 22. The depressions 17 and the V-shaped sockets 22 are vertically aligned so that firearms may be securely held in place during transportation. The second component is a strap 18 that removably extends between the upper ends 21 of the vertical frame members 11. The strap 18 keeps the tops of the cargo items secured within the depressions 17. Although in this embodiment the top receiving means 16 is a two-component system, the top receiving means 16 may consist of any system capable of adequately securing the tops of the cargo items and preventing lateral and tipping movement thereof.

An accessory rail attachment 15 is attached to each of the vertical frame members 11 between the lower end 20 and the upper end 21. This accessory rail attachment 15 is adapted such that it is capable of engaging within the support apertures disposed along the upper surface of an ATV flatbed side rail. Certain models of vehicles include a flatbed area with raised sidewalls. The present invention contemplates connection thereto by way of an apertured accessory rail or through-holes in the side rail itself, which are spaced at a given distance to accommodate the first and second accessory rail attachment 15 of the present invention. The accessory rail attachments 15 are angled such that the vertical frame members 11 are not flush against the exterior wall of the flatbed. This angle makes the horizontal base member 12 protrude slightly compared to the horizontal top member 13, and allows the mobile firearm rack to avoid interfering with the wheel and wheel well of the ATV. This also provides additional stability to the cargo items secured within the equipment rack because it causes the cargo items to comfortably rest within the lower receiving means 14 and the top receiving means 16.

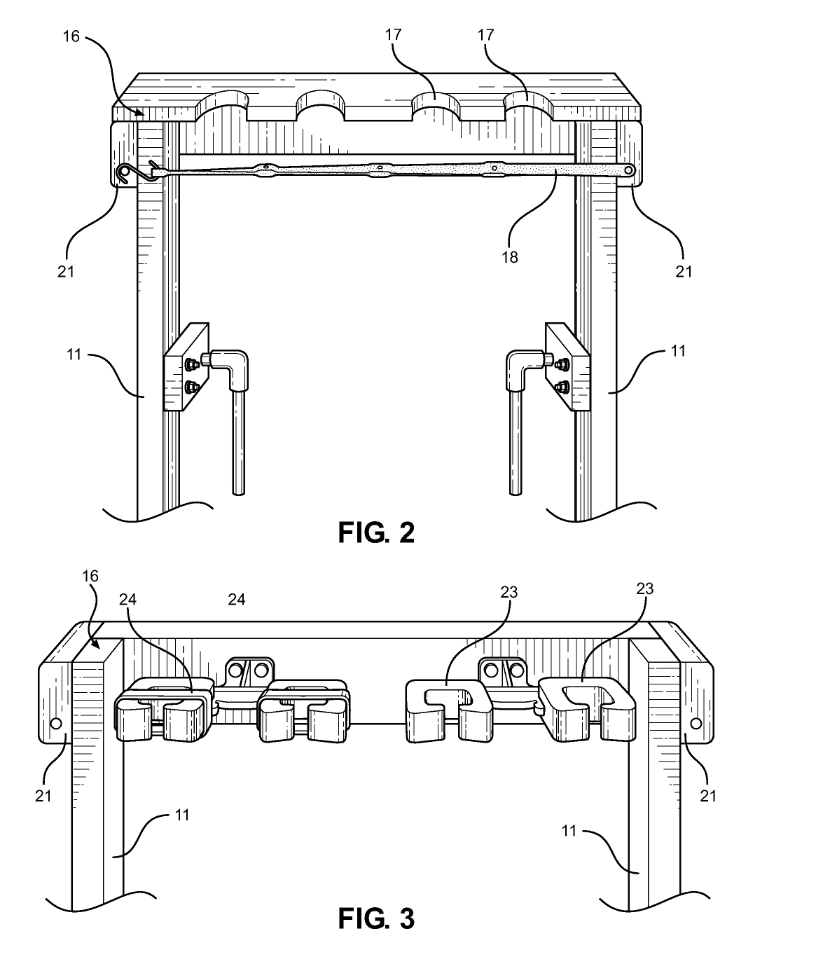

Referring now to FIG. 2, there is shown a front view of one of the contemplated embodiments of the present invention, focusing on this embodiment's top receiving means 16. In this embodiment, the top receiving means 16 consists of two components. The first component is a plurality of depressions 17 that are adapted to receive the tops of the cargo items. The number of depressions 17 corresponds to the number of lower receiving means 14. The second component is a strap 18 that removably extends between the upper ends 21 of the vertical frame members 11. The strap 18 keeps the tops of the cargo items secured within the depressions 17. The strap 18 may extend between the vertical frame members 11 at any point, as long as it adequately secures the tops of the cargo items within the depressions 17. In this embodiment, the strap 18 is removably attached on only one of the vertical frame members 11, but this invention contemplates embodiments where the strap 18 is removably attached to both vertical frame members 11.

Referring now to FIG. 3, there is shown the preferred embodiment of the mobile firearm rack in a similar view as FIG. 2. In this embodiment, the top receiving means 16 comprises a plurality of U-shaped notches 23 adapted to receive the barrels of firearms, the shafts of fishing rods, or the tops of other cargo items. The U-shaped notches 23 are comprised of a base attached to the horizontal top member 13, two arms extending from opposite sides of the base, and internally-pointing flanges at the tips of the arms that present a narrow opening for cargo items to enter or leave the notches. The U-shaped notches 23 are composed of a material that is rigid enough that items cannot escape the notches during normal jostling from an ATV trip, but also flexible enough that items that are wider than the narrow opening presented by the U-shaped notches 23 can nonetheless be pushed into the notch via the application of reasonable force.

The U-shaped notches 23 are intended to relatively easily accept cargo items, but be rigid enough to firmly secure the cargo items during transportation. The number of U-shaped notches 23 corresponds to the number of lower receiving means 14 on the upper surface 19 of the horizontal base member 12. The U-shaped notches 23 are vertically aligned with the lower receiving means 14 such that cargo items may be securely held in place during transport. Cargo items being firmly secured is paramount to the purpose of the invention because if certain types of cargo items, such as firearms, are improperly secured, then they pose a danger to the user and other individuals in the vicinity. Optionally, bands 24 may be placed around the arms of the U-shaped notches 23 to further ensure that the cargo items are properly secured. The bands 24 decrease the area in the interior of the U-shaped notches 23, thereby securing the cargo items more tightly against the base of the U-shaped notches 23 and preventing potential damage to cargo items from banging into the walls of U-shaped notches 23 or banging into other cargo items during transportation.

In the embodiment as shown in FIG. 3, the U-shaped notches 24 are supported in pairs from a common carrier. Each carrier supports a pair of notches 24 away from the top member while the carrier is mechanically fastened thereto. The notches 24 provide a firm grip of the cargo items by way of a base and a pair of aligned sides that form the U-shape, along with a pair of distal end, inwardly-directed lips that retain the cargo items within the U-shaped notch interior. The notch sides are deformable to allow the cargo items to be inserted into the notch interior, whereby the sides splay outward and the cargo items can be inserted thereinto before the sides and lip of the notches surround the cargo item and retain the same therein.

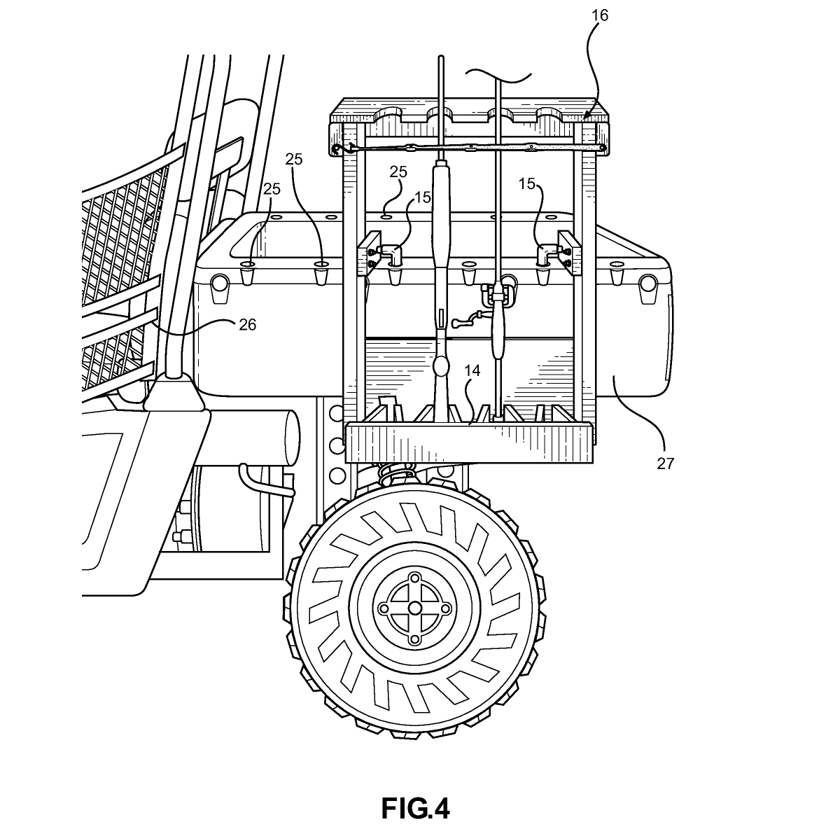

Referring now to FIG. 4, there is shown a perspective view of the mobile equipment rack, demonstrating how the accessory rail attachments 15 engage with the support apertures 25 of the side wall 27 of the ATV's flatbed cargo area to keep the mobile equipment rack vertical. The support apertures 25, the ATV 26, and the flatbed side wall 27 should not be construed in anyway to be part of the invention. They are merely provided to show the interaction between the mobile equipment rack and a contemplated ATV structure well suited for supporting the present rack in an upright and stable configuration during transport. This perspective view also demonstrates how cargo items are secured by the lower receiving means 14 and the top receiving means 16. This vertical storage system keeps the cargo items easily accessible while at the same time ensuring that they will not collide with each other during transport, thus reducing the risk of danger or damage to the cargo items.

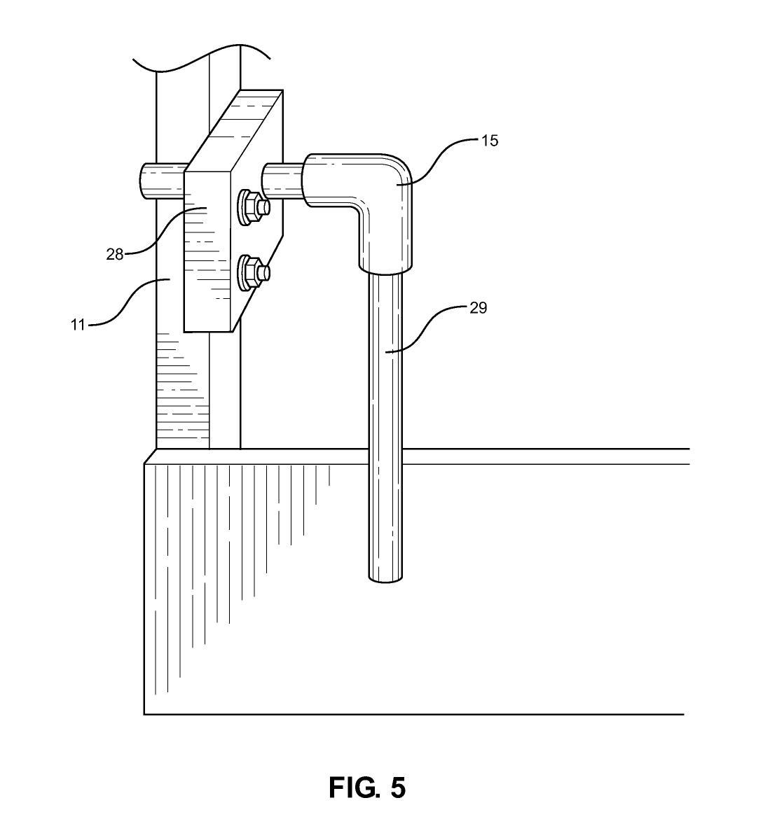

Referring now to FIG. 5, there is shown a close-up view of the preferred embodiment of an accessory rail attachment 15. This consists of an angled block 28 affixed to each of the vertical frame members 11. An elongated attachment member 29 extends from the angled block 28 and curves downwards. The attachment member 29 is an elongated member having a smaller diameter than the diameter of the corresponding support aperture, allowing the attachment member 29 to engage with the support aperture. This is merely one contemplated embodiment of the accessory rail attachment 15. The accessory rail attachments 15 may be of any configuration that permits the mobile equipment rack to engage with the support apertures of certain ATV models' flatbed side wall. The accessory rail attachments 15 are angled rearward with respect to the vertical frame members 11 such that the horizontal base member 12 protrudes slightly outward from the ATV side wall, whereby the ATV wheel or wheel well does not interfere with the mobile equipment rack and cargo items are tilted backward into the rack during transport. The slight outward angle ensures that the firearms or other equipment sit comfortably within the lower receiving means 14 and the top receiving means 16.

In use, the present mobile equipment rack is very well suited for securing and transporting firearms and other similarly sized objects. The rack vertically stores and separates the firearms such that they will not collide with each other or other objects during transportation, thus eliminating the risk of inadvertent discharge of the firearms. Furthermore, the storage rack allows individuals to quickly and easily access their firearms and because it hangs off the exterior wall of the ATV's flatbed wall, it saves space that can be used to store other objects.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A mobile equipment rack adapted to attach to an apertured accessory rail of an all-terrain vehicle, comprising:
a first and a second vertical frame member, each having an upper end and a lower end;
a horizontal base member secured at opposite ends to said lower ends of said first and second vertical frame member, said horizontal base member having an upper face comprising at least one lower receiving means adapted to receive the lower end of cargo items;
a horizontal top member secured at opposite ends to said upper ends of said first and second vertical frame member, said horizontal top member having top receiving means of the same number of said lower receiving means, said top receiving means adapted to receive the upper end of cargo items;
a first and second accessory rail attachment member adapted to engage through support apertures of an external support, each of said first and said rail attachment members extending from said vertical frame members to support said vehicle frame members in largely upright configuration.

2) The mobile equipment rack of claim 1, wherein said upper receiving means comprises U-shaped notches vertically aligned with said lower receiving means.

3) The mobile equipment rack of claim 2, wherein said lower receiving means comprises V-shaped sockets.

4) The mobile equipment rack of claim 2, further comprising a plurality of bands secured around said U-shaped notches.

5) The mobile equipment rack of claim 1, wherein said upper receiving means comprises depressions vertically aligned with said lower receiving means and a strap removably secured at opposite ends to said vertical frame members.

6) The mobile equipment rack of claim 5, wherein said lower receiving means comprises V-shaped sockets.

7) The mobile equipment rack of claim 1, wherein said lower receiving means comprises V-shaped sockets.
